(19) United States
(12) Patent Application Publication
(10) Pub. No.: US 2023/0099353 A1
(43) Pub. Date: Mar. 30, 2023

(54) DIGITAL PRINTING MACHINE AND METHOD FOR PRODUCING AND PRINTING A WORKPIECE

(71) Applicant: Hinterkopf GmbH, Eislingen/Fils (DE)

(72) Inventors: Joachim Weber, Bad Ditzenbach (DE); Joachim Schulz, Deggingen (DE)

(21) Appl. No.: 17/953,461

(22) Filed: Sep. 27, 2022

(30) Foreign Application Priority Data
Sep. 28, 2021 (EP) 21 199 532.9

(51) Int. Cl. B41J 3/407; B41J 3/54; B41M 5/00; B41M 1/40

(52) U.S. Cl. CPC B41J 3/40733; B41J 3/543; B41M 5/0088; B41M 1/40

(57) ABSTRACT

Digital printing machine for printing workpieces, including a print head carrier to which a print head for dispensing ink droplets in a printing direction and a drying unit for curing the ink droplets are attached, wherein the print head and the drying unit define a working space in which an application of a print image to an outer surface of a workpiece with the print head and a drying of the print image on the workpiece with the drying unit is provided, wherein the drying unit provides electromagnetic waves for a photochemical polymerization of the ink droplets, wherein the drying unit includes a radiation source to provide electromagnetic waves with an intensity maximum at a wavelength from the group of: 395 nanometers, 385 nanometers, 365 nanometers.

### BACKGROUND OF THE INVENTION

The invention relates to a digital printing machine, a method for producing and printing a workpiece.

From EP 3 473 446 B1 a digital printing machine is known, which comprises a printhead module and an inking unit, wherein the inking unit is configured for a provision of a printing ink to the printhead module and wherein a printhead carrier comprises a carrier interface configured for a coupling with a printhead interface, wherein the printing unit receptacle, the printing unit interface, the inking unit, the print head interface, the carrier interface and the print head module form a row arrangement arranged along the printing direction, wherein at least one ink reservoir and a drying module are arranged in a section arranged in the vertical direction below a workpiece plane.

### SUMMARY OF THE INVENTION

The object of the invention is to provide a digital printing machine, a method for producing and printing a workpiece, and a system for providing printed workpieces, with which an extension of cleaning intervals, within which cleaning work must be carried out in order to maintain the function of the print head, can be effected.

According to a first aspect, this task is solved by a digital printing machine for printing workpieces. In this regard, it is provided that the digital printing machine comprises a print head carrier to which a print head for dispensing ink droplets in a printing direction to a workpiece and a drying unit for curing the ink droplets on the workpiece are attached, the print head and the drying unit delimiting a working space in which an application of a print image to an outer surface of a workpiece with the print head and a drying of the print image on the workpiece with the drying unit is provided, wherein the drying unit is adapted to provide electromagnetic waves for a photo-chemical polymerization of the ink droplets and wherein the drying unit comprises a radiation source adapted to provide electromagnetic waves having an intensity maximum at a wavelength of 395 nanometers, preferably at a wavelength of 385 nanometers, in particular at a wavelength of 365 nanometers.

In a digital printing machine of this type, it is provided that the workpiece is arranged stationary in the working space for a limited period of time and performs a rotational movement, with an axis of rotation of the workpiece being aligned transversely to the printing direction. This makes it possible to generate a large-area print image on the outer surface of the workpiece, wherein the workpiece is typically a beverage can or and aerosol can with a cylindrical shape. Typically, the print head has at least one row of ink nozzles comprising a plurality of ink nozzles spaced linearly and at equal pitch, each of the ink to nozzles being configured for individual delivery of ink droplets in the print direction. As a result of the rotational movement of the workpiece, a plurality of rows of ink droplets aligned parallel to one another can thus be discharged onto the outer surface of the workpiece, thereby producing the printed image. The print image can thus have an extension that is a multiple of a line width of the ink droplet row emitted from the ink nozzles of the print head.

The rotation of the workpiece causes the printing area to move relative to the drying unit, so that the ink droplets applied to the outer surface of the workpiece come within the range of influence of the electromagnetic waves of the drying unit, so that the printing ink, which is chemically adapted to the electromagnetic waves of the drying unit is cured by photochemical polymerization.

In principle, it is assumed that the drying unit is arranged opposite the print head, since this can produce an advantageous shielding effect for the electromagnetic waves provided by the drying unit, which shielding effect is caused by the workpiece arranged in the working space. It is advantageous if a center beam of the radiation source of the drying unit is aligned opposite and parallel to the printing direction for the ink droplets. It is particularly advantageous if the center beam and the printing direction are arranged coaxially to each other.

Accordingly, the electromagnetic waves provided by the drying unit can in principle reach the print head, which would cause undesired curing of the printing ink and thus clogging of the ink nozzles of the print head. In practice, the drying unit is operated in such a way that an emission of electromagnetic waves is provided only if a workpiece is located in the working space, the presence of which interrupts an optical path between the at least one radiation source and the ink nozzles of the printhead.

However if the workpiece is made of a material which has light-conducting properties like a transparent plastic material, undesirable onward transmission of electromagnetic waves occurs from the radiation source to the printhead, so that undesirable curing of printing ink at the printhead can occur as a result. In this case the shielding function of the workpiece is at least partially replaced by a radiation transmission of the workpiece.

According to the invention, it is therefore provided that the drying unit is equipped with at least one radiation source which provides electromagnetic waves with an intensity to maximum at a wavelength of 395 nanometers. Preferably the drying unit is equipped exclusively with radiation sources which provide electromagnetic waves with an intensity maximum at a wavelength of 395 nanometers. By using such a radiation source, the electromagnetic rays of which are to be assigned to the range of ultraviolet light, further transmission of the electromagnetic rays in the workpiece, which can act in the manner of a light guide, is reduced or prevented due to the short wavelengths in comparison to longer-wavelength light which may be transmitted properly by the workpiece.

Accordingly, a radiation intensity level which occurs at the printhead does not effect a curing of the printing ink at the printhead. The choice of the radiation source which provides electromagnetic waves with the intensity maximum at the wavelength of 395 nanometers significantly reduces the risk of clogging of the ink nozzles due to undesired curing of the printing ink. Subsequently, a cleaning interval describing the time interval between two cleaning operations for the printhead can be extended compared to other drying units which provide longer wavelength electromagnetic waves.

Advantageous further embodiments of the invention are the subject of the subclaims.

Advantageously, the radiation source is a light emitting diode which is provided with a semiconductor selected from the group consisting of: aluminum nitride (AlN), aluminum gallium nitride (AlGaN), aluminum gallium indium nitride (AlGaInN), diamond (C), which semiconductor is designed to provide monochromatic electromagnetic waves. In principle, it can be assumed that a light emitting diode which is equipped with one of the aforementioned semiconductor materials is designed to emit monochromatic light, however, due to interactions of the light provided by the semiconductor with surrounding materials, there is a broadening of the wavelength spectrum provided by the light emitting diode.

In a further embodiment of the invention, the radiation source is configured to provide electromagnetic waves in a wavelength interval of less than 13 nanometers at 50 percent of the maximum radiation intensity and/or to provide electromagnetic waves in a wavelength interval of less than 20 nanometers at 25 percent of the maximum radiation intensity. This means that the radiation source emits electromagnetic waves with a narrow-band wavelength distribution so that, starting from that wavelength which determines the intensity maximum for the radiation source and which, in the case of a light-emitting diode, corresponds to the to wavelength of the monochromatic light emitted by the semiconductor, longer-wavelength electromagnetic waves in particular are provided only with very low intensity. Thus, in combination with the use of an appropriately tuned printing ink whose polymerization is triggered only upon irradiation with short-wave electromagnetic waves and taking into account the fact that, due to the short wavelengths, no relevant transmission of the electromagnetic waves through the workpiece occurs, drying of ink directly at the print head can be avoided.

In a further embodiment of the invention, it is provided that a short-pass filter, in particular designed as an absorption filter or as a dichroic filter, with a cut-off wavelength greater than 400 nanometers, preferably with a cut-off wavelength greater than 390 nanometers, in particular with a cut-off wavelength greater than 370 nanometers, is arranged between the radiation source and the working space. With such a short-pass filter, electromagnetic waves whose wavelength is greater than the cut-off wavelength of the short-pass filter are either absorbed in the filter material (absorption filter) or reflected at the filter (dichroic filter), depending on the type of short-pass filter, and therefore cannot penetrate to the workpiece and thus not to the print head. Preferably, the cut-off wavelength of the short-pass filter is a few nanometers longer than the wavelength at which the radiation source has its intensity maximum. For example, a radiation source whose intensity maximum is 365 nanometers is combined with a short-pass filter whose cut-off wavelength is 390 nanometers and preferably 370 nanometers.

With an appropriately tuned short-pass filter, wavelengths that could be emitted by the radiation source and guided from the workpiece to the print head are blocked at least to a large extent, preferably almost completely, and in particular completely. As a result the short-pass filter allows an increase in the design freedom for the workpiece. This design freedom relates in particular to the choice of material, since when using a short-pass filter of this type, less attention needs to be paid to ensuring that the workpiece material as such guarantees absorption of unwanted wavelengths. This is particularly important in the case of plastic materials, which would otherwise have to be equipped with a suitable absorber chemicals, which, however, can lead both to an increase in costs and to a change in material properties of the respective plastic material.

It is advantageous if the print head carrier is fixed to a machine frame on which a to conveying device for workpieces, in particular a workpiece rotary table rotatably mounted on the machine frame, is arranged, the conveying device being designed for supplying a workpiece into the working space and for rotating the workpiece in the working space about an axis of rotation oriented transversely to the printing direction. Such a digital printing machine can be used for printing large numbers of workpieces in a short time. Preferably the print head carrier is fixed in a stationary manner on a machine frame on which, if necessary, a number of further work stations such as, for example, further print head carriers and/or devices for the pre-treatment or post-treatment of workpieces before or after the execution of printing processes can also be provided.

It is preferably provided that the conveying device is designed for conveying the workpieces along a rectilinear or circular arc section-shaped conveying path and in doing so performs a stepping movement for the respective workpieces, i.e. a sequence of a movement of the workpiece during a movement phase and a standstill of the workpiece during a processing phase, in particular during the printing process.

Accordingly, it is envisaged that the workpieces remain in the working area and rotate about a rotation axis, the rotation axis being aligned transversely to the printing direction.

This measure ensures that, for example, an annular outer circumferential surface of the workpiece, which is arranged coaxially to the axis of rotation, can be at least partially printed.

The task of the invention is solved by a method for producing and printing a workpiece made of a transparent or translucent material with the following steps: Providing a workpiece in a working space of a digital printing machine, dispensing ink droplets from a print head onto a printing area of an outer surface of the workpiece, and generating a printed image on the outer surface by rotating the workpiece about an axis of rotation, curing the ink droplets by irradiating at least a partial area of the print image with electromagnetic waves provided by a radiation source whose intensity maximum is at a wavelength of 395 nanometers, preferably at a wavelength of 385 nanometers, in particular at a wavelength of 365 nanometers.

In a further development of the method, it is provided that the workpiece is made of a glass material which, in a wavelength range smaller than 400 nanometers, has an optical transmission of less than 25 percent, preferably of less than 15 percent, in particular of less than 5 percent. In this case, the workpiece itself acts in the manner of a short-pass filter and to thus supports the other measures for preventing the transmission of longer-wavelength electromagnetic waves to the print head.

In a further embodiment of the method, it is provided that the workpiece is made of plastic, the plastic having an ultraviolet radiation absorber selected from the group consisting of: 2-(2-hydroxyphenyl)-2H-benzotriazoles, (2-hydroxyphenyl)-s-triazines, hydroxybenzophenones, oxalanilides, titanium dioxide, iron oxide, zinc oxide, cadmium stearate. Such a workpiece ensures that longer wavelength electromagnetic waves, which could reach the printhead due to light conduction properties of the workpiece, are absorbed in the workpiece and thus cannot lead to undesired drying of the ink at the printhead.

In a further development of the method, it is provided that during the rotation of the workpiece about the axis of rotation, a distance between the outer surface of the workpiece, which is provided with the print image, and the print head is constant. Preferably, it is provided that the workpiece is rotationally symmetrical at least in the region of the print image. Particularly preferably, it is provided that the entire workpiece is rotationally symmetrical, in particular in the manner of a circular cylindrical sleeve.

The problem of the invention is solved by a system for providing printed workpieces, which comprises a digital printing machine according to the invention as well as workpieces, wherein the workpieces are made of a glass material which, in a wavelength range smaller than 400 nanometers, has an optical transmission for electromagnetic waves of less than 25 percent, preferably less than 15 percent, in particular less than 5 percent, and/or with workpieces which are made of a plastic material. The plastic material comprises an ultraviolet radiation absorber selected from the group consisting of: 2-(2-hydroxyphenyl)-2H-benzotriazoles, (2-hydroxyphenyl)-s-triazines, hydroxybenzophenones, oxalanilides, titanium dioxide, iron oxide, zinc oxide, cadmium stearate.

### BRIEF DESCRIPTION OF THE DRAWINGS

An advantageous embodiment of the invention is shown in the drawing. Here shows:

FIG. 1 a strictly schematic side view of a digital printing machine with a print head carrier, a print head, a drying unit as well as a workpiece which is received on a rotatably mounted spindle, and

FIG. 2 a strictly schematic front view of the digital printing machine according to FIG. 1, wherein the print head carrier is not shown.

### DETAILED DESCRIPTION

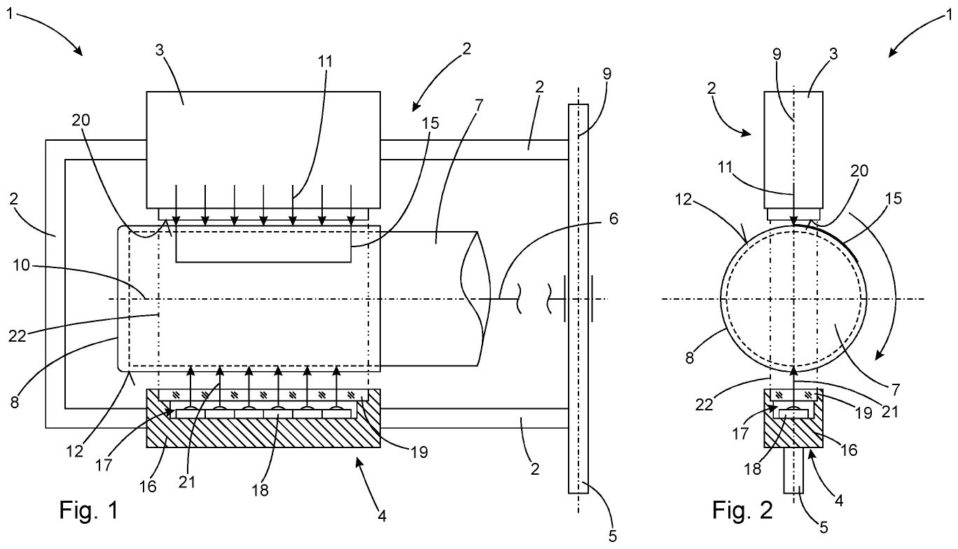

A digital printing machine 1 shown strictly schematically in FIGS. 1 and 2 comprises a print head carrier 2 shown only schematically, to which a print head 3 also shown only schematically and a drying unit 4 shown schematically are fixedly attached. The print head carrier 2 is connected to a machine frame 5, which is also shown only schematically and which is stationary in a manner not shown in more detail on a floor plate of a production hall which is not shown.

A workpiece rotary table 6, shown only symbolically, is mounted on the machine frame 5 so as to be rotatably movable about an axis of rotation 9, wherein the workpiece rotary table 6 may in practice be of disc-shaped design, for example, and is provided on a radially outer circumferential surface with a plurality of radially aligned spindles, of which only one spindle 7 is shown in FIG. 1 as an example. The spindle 7 is accommodated on the workpiece rotary table 6 so as to be rotatable about an axis of rotation 10 and, in purely exemplary fashion, is of circular-cylindrical profile. The spindle 7 serves to receive a purely exemplary circular sleeve-shaped workpiece 8, which may be, for example, a plastic vessel made of a transparent or translucent plastic material.

The print head 3 is provided on an underside 20 opposite to an outer surface 12 of the workpiece 8 behind a plurality of ink nozzles, not shown, which are arranged along a straight line at equal pitch, said straight line being aligned parallel to the axis of rotation 10. Each of the ink nozzles can be individually controlled by a controller for the respective print head 3, which controller is not shown, and thereby enables a droplet of ink, which is not shown, to be dispensed in a printing direction 11. Purely exemplarily, the spindle 7 with the workpiece 8 received thereon and the print head 3 are aligned with respect to each other during an execution of a printing process in such a way that the printing direction 11 is identical with a surface normal to the outer surface 12 of the workpiece 8. Due to the arrangement of the ink nozzles, which are not shown, the print head 3 can discharge a freely selectable number of ink droplets onto the outer surface 12 of the workpiece 8 along the straight line which is aligned parallel to the axis of rotation 10. Thus, to create a printed image on the outer surface 12, it is intended to rotate the workpiece 8 about the axis of rotation 10 so that the printed image can be created by a plurality of juxtaposed ink droplets. The area of the outer surface 12 of the workpiece 8 which can be printed by the print head 3 is also referred to as the printing area 15, and is in the form of a circular cylindrical section.

Opposite the print head 3, the drying unit 4 is arranged, as can be seen in particular from the illustration in FIG. 2. Together with the print head 3, the drying unit 4 delimits a working space 22 into which the spindle 7 provided with the respective workpiece 8 can be swiveled by a rotation of the workpiece rotary table 6 about the axis of rotation 9. For this purpose, the workpiece rotary table 6 performs a rotary step movement in which a sequence of a pivoting movement and a standstill phase is provided, the printing of the workpiece 8 being carried out during the standstill phase and the workpiece 8 being set into a relative movement with respect to the print head 3 during this standstill phase by the rotation of the spindle 7 about the axis of rotation 10.

The drying unit 4 comprises a housing 16 which is provided with a recess 17 in which, purely by way of example, a plurality of radiation sources 18 in the form of light-emitting diodes are arranged. Each of the radiation sources 18 is thereby provided for the provision of electromagnetic waves with a spectral wavelength distribution in which an intensity maximum lies at the wavelength of 395 nanometers, preferably of 385 nanometers, in particular of 365 nanometers. Preferably, all radiation sources 18 are of identical design and accordingly each have the same spectral wavelength distribution.

The radiation sources 18 are designed and arranged in the recess 17 in such a way that a central beam 21 of the respective radiation source 18, which indicates the spatial direction in which radiation source 18 has its maximum intensity, is aligned parallel and, in particular, coaxially with the printing direction 11 of the respective opposite ink nozzle.

The recess 17 in the housing 16 is covered by a filter 19 whose optical properties are selected such that wavelengths of the electromagnetic waves provided by radiation source 18 which lie above (are longer than) a predetermined cut-off wavelength of the filter 19 are at least almost completely blocked. Depending on the design of the filter 19, this is achieved by absorption of the electromagnetic waves or by reflection of the electromagnetic waves. Purely by way of example, it is provided that the cut-off wavelength of the filter 19 is located a few nanometers above the wavelength at which the radiation source 18 has its intensity maximum.

The workpiece 8 is preferably made of an optically transparent or an optically translucent material, in particular glass or plastic or a composite of glass and plastic, and therefore has the property that visible light can pass through the workpiece 8 with low loss. The workpiece 8 thus forms a waveguide for electromagnetic waves which wavelengths are located in a wavelength range from 380 nanometers to 780 nanometers. To avoid onward transmission of electromagnetic waves, which are provided by the drying unit 4 to the outer surface 12 of the workpiece 8 for drying the ink droplets, as far as the print head 3, the workpiece 8 is designed by suitable material selection in a manner by which onward transmission of electromagnetic waves with a wavelength of less than 400 nanometers, preferably with a wavelength of less than 390 nanometers, in particular with a wavelength of less than 370 nanometers, is at least largely prevented, even when the workpiece 8 is transparent or translucent.

Such properties can be realized when glass is used as the material for the workpiece 8 by means of corresponding absorbers, which are preferably of such a nature that the absorbers do not change, or only slightly change, the other properties of the glass material used. When plastic is used for the workpiece 8, absorbers can likewise be used which are adapted to the respective plastic material.

Accordingly, when the printing machine 1 and the workpiece 8 are considered together, the result is a printing system 30 which, based on the characteristics summarized below, enables printing of transparent or translucent workpieces by the ink jet printing method with a guarantee of long cleaning intervals for cleaning the print head. The ink for the ink droplets emitted by the print head 3 through the ink jet nozzles (not shown) in the printing direction 11 onto the printing area 15 of the workpiece 8 is configured for polymerization with electromagnetic waves whose wavelengths are less than 400 nanometers, preferably less than 390 nanometers, in particular less than 370 nanometers.

The workpiece 8 is made of a transparent material, in particular glass and/or plastic, the materials used for this purpose ensuring at least partial absorption for electromagnetic waves whose wavelengths are smaller than 400 nanometers, preferably smaller than 390 nanometers, in particular smaller than 370 nanometers, by means of corresponding absorbers.

The at least one radiation source 18 is designed to provide electromagnetic waves having an intensity maximum at a wavelength of 395 nanometers, preferably at a wavelength of 385 nanometers, in particular at a wavelength of 365 nanometers.

It is further provided that between the at least one radiation source 18 and the working space 22 defined by the print head 3 and the drying unit 4, a filter 19 is arranged which is designed as a short-pass filter with a cut-off wavelength greater than 400 nanometers, preferably with a cut-off wavelength greater than 390 nanometers, in particular with a cut-off wavelength greater than 370 nanometers.

What is claimed is:

1. A digital printing machine for printing workpieces, having a print head carrier to which a print head for dispensing ink droplets in a printing direction and a drying unit for curing the ink droplets are attached, wherein the printing head and the drying unit define a working space in which an application of a printing image to an outer surface of a workpiece with the printing head and a drying of the printing image on the workpiece with the drying unit is provided, wherein the drying unit provides electromagnetic waves for photochemical polymerization of the ink droplets and wherein the drying unit comprises a radiation source to provide electromagnetic waves having an intensity maximum at a wavelength from the group: 395 nanometers, 385 nanometers, 365 nanometers.

2. The digital printing machine according to claim 1, wherein the radiation source is a light-emitting diode comprising a semiconductor from the group: aluminum nitride, aluminum gallium nitride, aluminum gallium indium nitride, diamond, to provide monochromatic electromagnetic waves.

3. The digital printing machine according to claim 1, wherein the radiation source is configured at 50 percent of the maximum radiation intensity for providing electromagnetic waves in a wavelength interval of less than 13 nanometers and/or at 25 percent of the maximum radiation intensity for providing electromagnetic waves in a wavelength interval of less than 20 nanometers.

4. The digital printing machine according to claim 1, wherein a short-pass filter from the group: absorption filter, dichroic filter, with a cut-off wavelength from the group: greater than 400 nanometers, greater than 390 nanometers, greater than 370 nanometers, is arranged between the radiation source and the working space.

5. The digital printing machine according to claim 1, wherein the print head carrier is fixed to a machine frame on which a conveying device for workpieces is arranged to supply workpieces into the working space and to rotate the workpiece in the working space about an axis of rotation oriented transversely to the printing direction.

6. A method for producing and printing a workpiece from a transparent or translucent material, the method having the steps:
providing a workpiece in a working space of a digital printing machine;
dispensing ink droplets from a print head onto a printing area of an outer surface of the workpiece;
producing a printed image on the outer surface by rotating the workpiece about an axis of rotation; and
curing the ink droplets by irradiating at least a partial area of the print image with electromagnetic waves provided by a radiation source whose intensity maximum is at a to wavelength from the group of: 395 nanometers, 385 nanometers, 365 nanometers.

7. The method according to claim 6, wherein the workpiece is made of a glass material which, in a wavelength range smaller than 400 nanometers, has an optical transmission of less than 25 percent.

8. The method according to claim 6, wherein the workpiece is made of plastic, the plastic having an absorber for ultraviolet radiation selected from the group: 2-(2-hydroxyphenyl)-2H-benzotriazoles, (2-hydroxyphenyl)-s-triazines, hydroxybenzophenones, oxalanilides, titanium dioxide, iron oxide, zinc oxide, cadmium stearate.

9. The method according to claim 6, wherein, during the rotation of the workpiece about the axis of rotation, a distance between the outer surface of the workpiece, which is provided with the printed image, and the print head is constant.
